(19) United States
(12) Patent Application Publication
(10) Pub. No.: US 2009/0190984 A1
(43) Pub. Date: Jul. 30, 2009

(54) DECURLING MECHANISM

(75) Inventors: Akihito YAMAMOTO, Wakayama (JP); Yoshitsugu TOKAI, Wakayama (JP)

Correspondence Address: Studebaker & Brackett PC, 1890 Preston White Drive, Suite 105, Reston, VA, 20191, US

(73) Assignee: NORITSU KOKI CO., LTD., Wakayama (JP)

(21) Appl. No.: 12/360,255

(22) Filed: Jan. 27, 2009

(30) Foreign Application Priority Data
Jan. 29, 2008 (JP) 2008-018322

(51) Int. Cl. G03G 15/00

(52) U.S. Cl. 399/406

(57) ABSTRACT

A decurling mechanism is configured so that a position changing roller moves a decurling roller among a plurality of decurling positions from the weakest decurling position to the strong decurling position. In this manner, the decurling force applied to each piece of paper web is set large when the piece of paper web has a length not smaller than a predetermined value, but set small when the piece of paper web has a length smaller than the predetermined value.

### CROSS-REFERENCE TO RELATED APPLICATION

This application claims priority under 35 USC 119 to Japanese Patent Application No. 2008-18322 filed on Jan. 29, 2008, the entire contents of which are incorporated herein by reference.

### BACKGROUND OF THE INVENTION

(a) Field of the Invention

This invention relates to decurling mechanisms.

(b) Description of the Related Art

In conventional printers used such as for photographic printing systems, their printer body includes a paper containing part for containing a long web of rolled paper (a long rolled paper web). The paper web contained in the paper containing part is fed to a printing part and printed therein by a print head, such as an inkjet print head. The printed paper web is cut in a given length and then conveyed to an output point at which, for example, a paper output tray is disposed.

Since the paper web is rolled around a core, it has a curled shape due to a core set. Therefore, if cut pieces of the curled paper web are conveyed to the output point, such as a paper output tray, as they are, they rob one another such as on the paper output tray upon stacking one on another and their printing surfaces may be thereby likely to get scratched. In addition, the curled cut pieces of paper look ugly. Therefore, there is a demand to correct curls of printed pieces of paper to flatten it out prior to presentation to customers.

Published Japanese Patent Application No. 2006-193315 discloses a technique in which a printer is provided with a decurling mechanism for decurling paper (correcting a curl of the paper) by bending the paper from its rising side due to the curl. The above document describes that although part of a rolled paper web near the outer periphery thereof and part thereof near the core differ from each other in the degree of curl, the decurling mechanism can appropriately adjust the decurling force according to the current diameter of the paper web rolled around the core.

### SUMMARY OF THE INVENTION

However, the above conventional decurling mechanism adjusts the decurling force in consideration only of the remaining amount of the paper web, i.e., the current diameter of the paper web rolled around the core and, therefore, may apply to the paper web a stronger decurling force than necessary. Specifically, the degree of curl does not depend only on the current diameter of the paper web around the core. Therefore, if the decurling force set in consideration only of the current diameter of the paper web is too strong for the degree of actual curl, the paper web is unnecessarily curled opposite to the actual curl, which is unfavorable.

Furthermore, if the paper web is strongly curled because it is long, the decurling force set in consideration only of its current diameter may be too weak for the degree of its actual curl. This causes a problem that the curl of the paper web cannot sufficiently be corrected.

The present invention has been made in view of the foregoing points and, therefore, an object of the invention is to provide a decurling mechanism that can appropriately adjust the decurling force according to the degree of curl of the paper.

To attain the above object, in the present invention, the decurling force is appropriately set according to the length or other factors of the paper.

Specifically, the present invention is directed to a decurling mechanism for performing a decurling process of correcting a curl of paper and takes the following solutions.

In a first aspect of the invention, the decurling mechanism is configured so that the decurling force applied to the piece of paper is set small when the piece of paper has a length smaller than a predetermined value but set large when the piece of paper has a length not smaller than the predetermined value.

According to the first aspect of the invention, the strength of the decurling force applied to the piece of paper is adjusted according to the length of the piece of paper. Therefore, the decurling force can be appropriately adjusted according to the degree of curl of the piece of paper to correct the curl.

Specifically, a longer piece of paper can be determined to be more flexible and more strongly curled. Therefore, if the piece of paper has a length not smaller than the predetermined value, the decurling force applied to the piece of paper is set large. On the other hand, when the piece of paper has a length smaller than the predetermined value, the decurling force applied to the piece of paper is set small. Thus, it can be prevented that a stronger decurling force than necessary is applied to the piece of paper and that the piece of paper is curled opposite to the actual curl. Furthermore, it can be prevented that a weak decurling force for the degree of actual curl is applied to the piece of paper. This eliminates an inconvenience that the curl cannot sufficiently be corrected.

A second aspect of the invention is the decurling mechanism according to the first aspect of the invention, wherein the decurling mechanism is configured to adjust the strength of the decurling force applied to the piece of paper according to the material of the paper.

According to the second aspect of the invention, the strength of the decurling force applied to the piece of paper is adjusted according to the material of the paper. Therefore, the decurling force can be appropriately adjusted according to the degree of curl of the piece of the paper to correct the curl.

Specifically, paper made of a hard material having a strong elasticity is difficult to flex. Therefore, a large decurling force is set for such paper, while a small decurling force is set for paper made of a relatively soft material. In this manner, an appropriate decurling force with which the piece of paper is easy to decurl can be applied to the piece of paper.

A third aspect of the invention is the decurling mechanism according to the first aspect of the invention, wherein the decurling mechanism is configured to adjust the strength of the decurling force applied to the piece of paper according to the elapsed time from the date of production of the paper.

According to the third aspect of the invention, the strength of the decurling force applied to the piece of paper is adjusted according to the elapsed time from the date of production of the paper. Therefore, the decurling force can be appropriately adjusted according to the degree of curl of the piece of the paper to correct the curl.

Specifically, if a predetermined period of time has passed since the date of production of the piece of paper being conveyed to the decurling mechanism, the piece of paper can be determined to be strongly curled. Therefore, the decurling force applied to the piece of paper is set large. On the other hand, if the predetermined period of time has not yet passed since the date of production, the decurling force applied to the piece of paper is set small. In this manner, an appropriate decurling force with which the piece of paper is easy to decurl can be applied to the piece of paper.

A fourth aspect of the invention is the decurling mechanism according to the first aspect of the invention, wherein the decurling mechanism includes: a conveyance roller for conveying the piece of paper to a predetermined paper output point; a decurling roller, disposed travelably around the conveyance roller, for pinching the piece of paper together with the conveyance roller; and a roller position changing mechanism for changing the relative position of the decurling roller to the conveyance roller to at least two positions including a decurling position in which the piece of paper is conveyed while being decurled and a conveyance position in which the piece of paper is conveyed without being decurled, the decurling position comprises a plurality of decurling positions set substantially along the roller surface of the conveyance roller, and the roller position changing mechanism is configured to adjust the strength of the decurling force applied to the piece of paper by moving the decurling roller among the plurality of decurling positions.

According to the fourth aspect of the invention, the strength of the decurling force applied to the piece of paper is adjusted by moving the decurling roller among the plurality of decurling positions. Therefore, an appropriate decurling force to the shape of a curl of each piece of paper can be applied to the piece of paper. In other words, the decurling force can be easily fine-adjusted simply by changing the relative position of the decurling roller to the conveyance roller.

As described so far, in the decurling mechanism according to the present invention, the strength of the decurling force applied to each piece of paper is adjusted according to various factors including the length of the piece of paper and the material thereof. Therefore, the decurling force can be appropriately adjusted according to the degree of curl of each piece of paper to correct the curl. Thus, it can be prevented that a stronger decurling force than necessary is applied to the piece of paper and that the piece of paper is curled opposite to the actual curl. Furthermore, it can be prevented that a weak decurling force for the degree of actual curl is applied to the piece of paper. This eliminates an inconvenience that the curl cannot sufficiently be corrected.

### BRIEF DESCRIPTION OF THE DRAWINGS

FIG. 1 is a perspective view showing the appearance of an inkjet printer including a decurling unit according to a first example embodiment of the present invention.

FIG. 2 is a perspective view showing the structure of the inkjet printer inside a housing.

FIG. 3 is a plan view showing the structure of the inkjet printer inside the housing.

FIG. 4 is a front view showing the structure of the inkjet printer inside the housing.

FIG. 5 is a schematic diagram of the inkjet printer when viewed from the left of the housing, showing a conveyance path of printing paper.

FIG. 6 is a cross-sectional view showing the structure of a drying unit and the decurling unit when viewed from the left of the housing.

FIG. 7 is a perspective view showing the structure of the inkjet printer around a paper output port when viewed from the front of the housing.

FIG. 8 is a front view showing the structure of the inkjet printer around the paper output port when viewed from the front of the housing.

FIG. 9 is a side view of the decurling unit when a decurling roller is positioned in a pinch release position.

FIG. 10 is a side view of the decurling unit when the decurling roller is positioned in a conveyance position.

FIG. 11 is a side view of the decurling unit when the decurling roller is positioned in a decurling position.

FIG. 12 is a perspective view showing the structure of an inkjet printer including a decurling unit according to a second example embodiment of the present invention.

FIG. 13 is a plan view showing the structure of the inkjet printer according to the second example embodiment of the present invention.

### DETAILED DESCRIPTION OF THE INVENTION

A description is given below of example embodiments of the present invention with reference to the drawings. The following example embodiments are merely illustrative in nature and are not intended to limit the scope, applications and use of the invention.

### First Example Embodiment

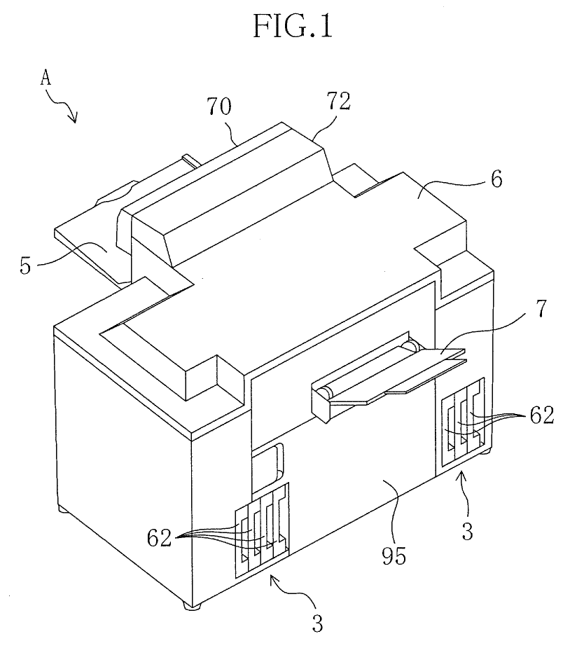

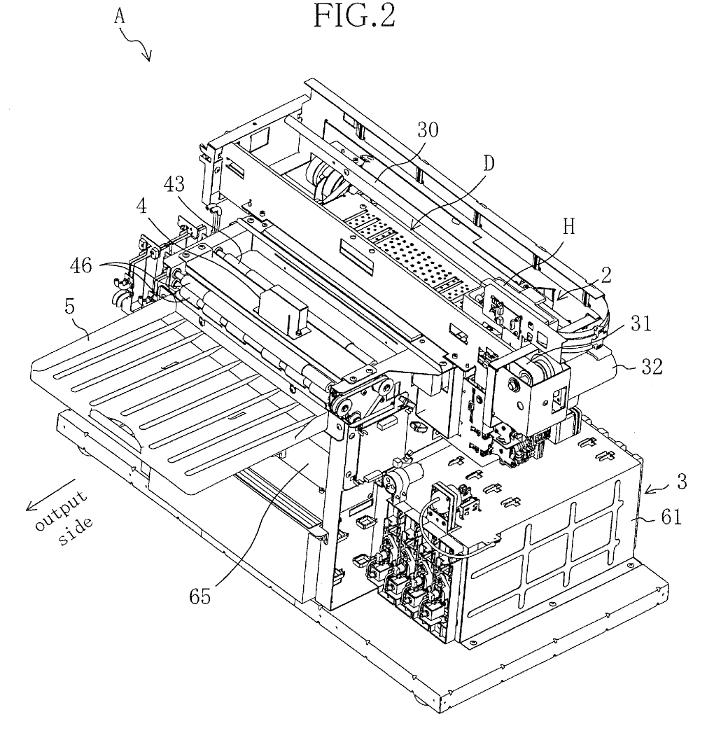

FIG. 1 shows the appearance of an inkjet printer including a decurling unit (decurling mechanism) according to a first example embodiment of the present invention, and FIGS. 2 to 5 show the internal structure of the inkjet printer. The inkjet printer A is used for a photographic printing system and, for example, used for printing photographic images on printing paper P1 or P2 based on image data transmitted via a communication cable from a reception block for obtaining the image data and correcting it as necessary. More specifically, the inkjet printer A is configured to be capable of performing an automatic printing for pulling out one end of a long roll of printing paper P2 and printing an image on the printing surface of the roll of printing paper P2 (hereinafter, referred to as a paper web P2) and a manual-feed printing for printing an image on the printing surface of a sheet of printing paper P1 (hereinafter, referred to as a paper sheet P1) previously cut in a given size.

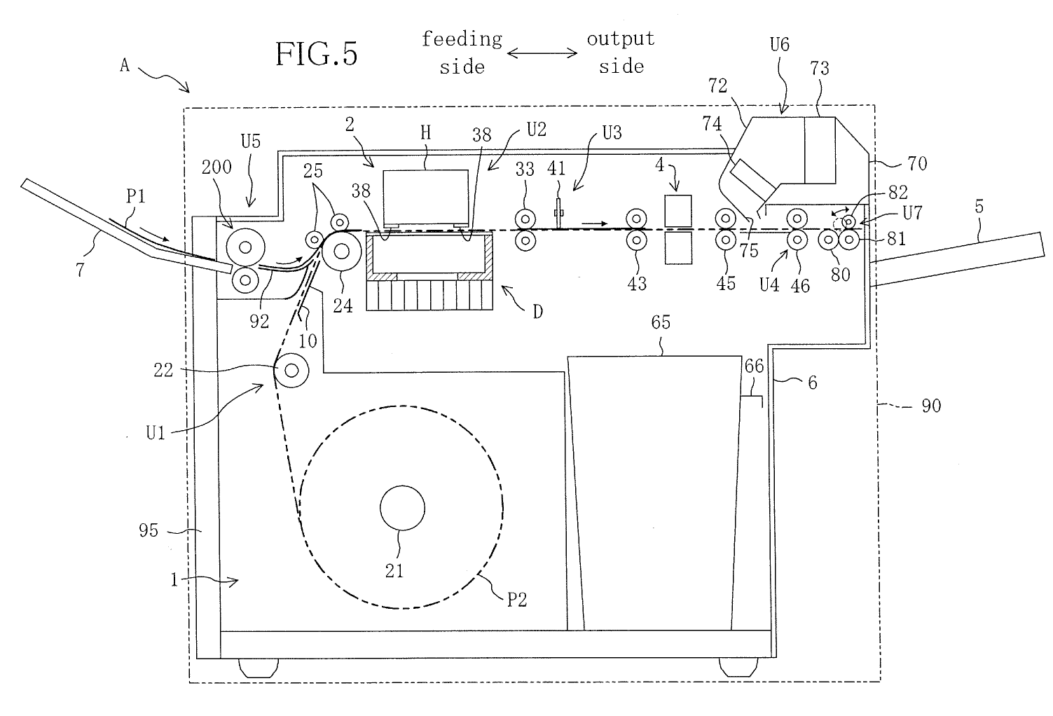

When in the following description the paper sheet P1 and the paper web P2 need not be particularly distinguished, they are referred to as printing paper P1 or P2. Furthermore, the printing surface means the surface on which an image is to be printed. The printing surface of each paper sheet P1 is determined when the paper sheet P1 is set on a manual-feed tray 7 (see FIG. 5). Specifically, the printing surface is the side of the paper sheet P1 facing upward when the paper sheet P1 is set on the manual-feed tray 7. On the other hand, the printing surface of the paper web P2 is the side thereof facing radially outward when the paper web P2 is rolled.

### General Structure

As shown in FIGS. 1 to 5, the inkjet printer A includes a printer body 90, a manual-feed tray 7 for manually setting a paper sheet P1 thereon and feeding it therefrom into the printer body 90, and a paper output tray 5 for receiving pieces of printing paper P1 or P2 output from the printer body 90.

The printer body 90 includes: a housing 6; a paper roll containing part 1 disposed in a lower part of the interior of the housing 6 and containing a paper web P2 rolled with its printing surface outside; a printing part 2 (see FIGS. 2 and 5), disposed in an upper part of the interior of the housing 6 (above the paper roll containing part 1), for printing based on image data an image on the printing surface of the paper sheet P1 fed from the manual-feed tray 7 or the printing surface of the paper web P2 pulled out of the paper roll containing part 1; ink storages 3, located in the lower part of the interior of the housing 6 on both sides of the paper roll containing part 1, for storing ink to be supplied to the printing part 2; and a roller unit 200, disposed on an upper part of a cover member 95 attached to the housing 6 to be freely opened and closed, for conveying and feeding a paper sheet P1 set on the manual-feed tray 7 towards the printing part 2 when the cover member 95 is closed.

Disposed in the upper part of the housing 6 and downstream of the printing part 2 in the direction of paper conveyance are a roller cutter 41 for cutting out an unnecessary part of printed printing paper P1 or P2, a back printing unit 4 for printing a serial number on the back side of each piece of printing paper P1 or P2, a drying unit U6 for drying the piece of printing paper P1 or P2 printed in the printing part 2, a paper output unit U4 for conveying the piece of printing paper P1 or P2 printed in the printing part 2 further downstream; and a decurling unit U7 for performing a decurling process of correcting the curl of the paper web P2. Disposed downstream of the decurling unit U7 in the direction of paper conveyance is the paper output tray 5, extending outside from a paper output port in the housing 6, for receiving pieces of printing paper P1 or P2 delivered by the decurling unit U7 and placing them thereon.

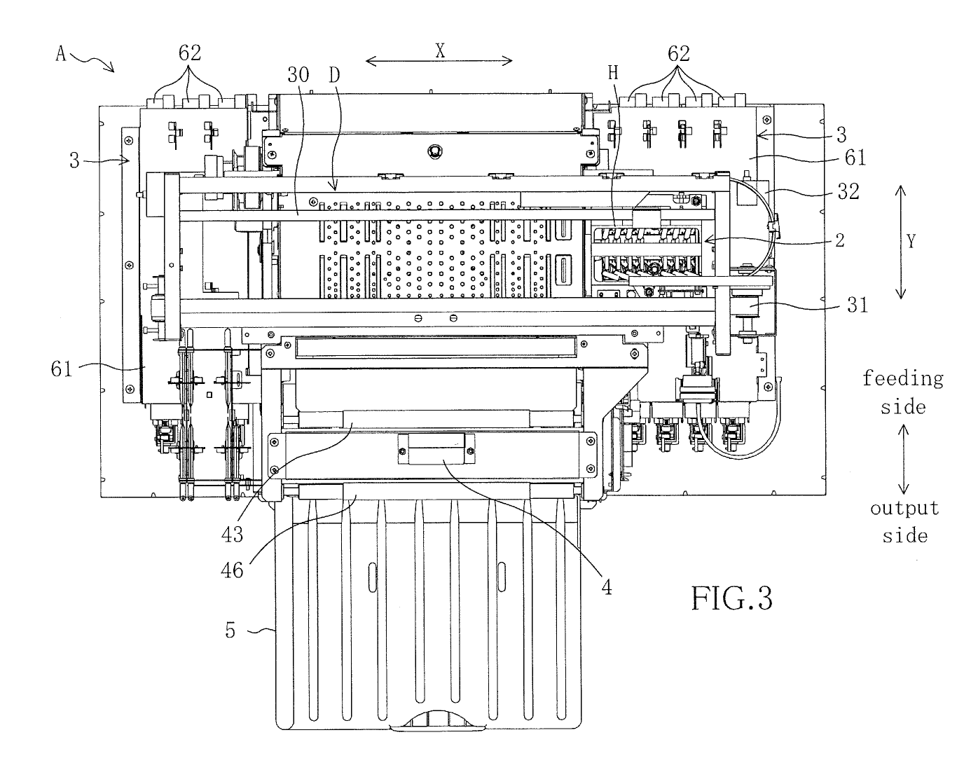

In the first example embodiment, the side of the housing 6 towards the paper output tray 5 (“output side” shown in FIG. 3) is referred to as the housing front side, the side thereof opposite to the paper output tray 5 (“feeding side” shown in FIG. 3) is referred to as the housing rear side, the left side thereof as viewed from the housing front side is referred to as the housing left side, and the right side thereof as viewed from the housing front side is referred to as the housing right side. Therefore, the right-to-left direction in FIG. 5 is the housing front-to-rear direction and the direction orthogonal to the drawing sheet of FIG. 5 is the housing right-to-left direction. The housing right-to-left direction coincides with the width direction of the paper sheet P1 set on and fed from the manual-feed tray 7 and the width direction of the paper web P2 contained in and fed from the paper roll containing part 1.

### Paper Conveyance Mechanism

As shown in FIG. 5, the inkjet printer A is provided with a paper conveyance mechanism for pulling the leading edge of a paper web P2 out of the paper roll containing part 1 and conveying it along a given conveyance path. To form the conveyance path, the paper conveyance mechanism includes, in order from the feed unit U1 for feeding a paper web P2, the feed unit U1, a printing unit U2, a cutter unit U3, the drying unit U6, the paper output unit U4 and the decurling unit U7. Thus, image data is printed on the printing surface of the printing paper P1 or P2 located on the conveyance path in the printing unit U2 provided in the printing part 2.

In the first example embodiment, for another paper feed path other than the feed path of a paper web P2 from the feed unit U1 to the printing unit U2, the paper conveyance mechanism further includes a manual-feed unit U5 configured to pull in a paper sheet P1 from the manual-feed tray 7 and feed it to the printing part 2.

The paper conveyance mechanism is configured so that, in printing on a paper web P2, the feed unit U1 feeds the paper web P2 set in the paper roll containing part 1 to the printing unit U2, the printing unit U2 then prints image data on the fed paper web P2 with the print head H while conveying the paper web P2. Then, the paper conveyance mechanism coveys the printed paper web P2 to the cutter unit U3, the cutter unit U3 cuts the paper web P2 in a given print size, the drying unit U6 then dries the cut piece of paper web P2, and the paper conveyance mechanism conveys the cut piece of paper web P2 out to the paper output tray 5 while the decurling unit U7 decurls the cut piece of paper web P2. Hereinafter, the upstream side and downstream side in the direction of conveyance of the paper web P2 being conveyed during printing is referred to simply as the upstream side and downstream side, respectively.

The feed unit U1 includes a core roller 21 for winding a paper web P2 in a roll thereon to contain the rolled paper web P2 in the paper roll containing part 1, a transverse restriction roller 22 for restricting the transverse position of the paper web P2 pulled out of the core roller 21, a conveyance drive roller 24 capable of being driven into rotation by an unshown electric motor to convey the paper web P2, and two pinch rollers 25 opposed to the conveyance drive roller 24 and engageable against the conveyance drive roller 24 to pinch the paper web P2 together with the conveyance drive roller 24.

The feed unit U1 is configured to pull the paper web P2 out of the paper roll containing part 1 and also feed it to the printing part 2 by the rotation of the conveyance drive roller 24.

The conveyance drive roller 24 is configured to be rotated forward by an unshown electric motor to pull the paper web P2 out of the paper roll containing part 1 and feed it to the printing part 2 and rotated backward by the electric motor to return the paper web P2 to the paper roll containing part 1.

Thus, the inkjet printer A can cut off the printed part of the paper web P2 into a given size by the cutter unit U3 downstream of the printing part 2, then return the remaining paper web P2 after the cutting upstream and restart printing with the leading edge of the remaining paper web P2 or can return the paper web P2 after the cutting into the paper roll containing part 1, feed a cut paper sheet P1 to the printing part 2 through the manual-feed unit U5 and print on it. Furthermore, in replacing the paper web P2 with new one, part of the paper web P2 pulled out of the paper roll containing part 1 can be returned into the paper roll containing part 1.

The printing unit U2 includes: the print head H for ejecting ink to the printing paper P1 or P2 and forming an image on it; a paper holder D for holding by suction the printing paper P1 or P2 at a position allowing printing of the print head H; and a pair of paper conveyance rollers 33 disposed downstream of the paper holder D and engaged against each other. The conveyance drive roller 24 and the pinch rollers 25 in the feed unit U1 are used also as components of the printing unit U2 and act to convey the printing paper P1 or P2 in the printing unit U2.

The print head H is configured to be movable along a rail 30 extending in a main scanning direction X (see FIG. 3) coinciding with the width direction of the printing paper P1 or P2 (i.e., the housing right-to-left direction). Specifically, when the rotational force of a drive motor 32 is transmitted through a pulley to a drive belt 31, the print head H moves in the main scanning direction X according to the amount of rotation of the drive belt 31.

The print head H further includes two head units 38 and 38 (see FIG. 5) arranged along a sub-scanning direction Y (see FIG. 3) orthogonal to the main scanning direction X and coinciding with the direction of travel of the printing paper P1 or P2 (i.e., the housing front-to-rear direction). The print head H is configured to print a given image or characters on the printing paper P1 or P2 by ejecting ink through ink-jet nozzles (not shown) formed in these two head units 38 and 38.

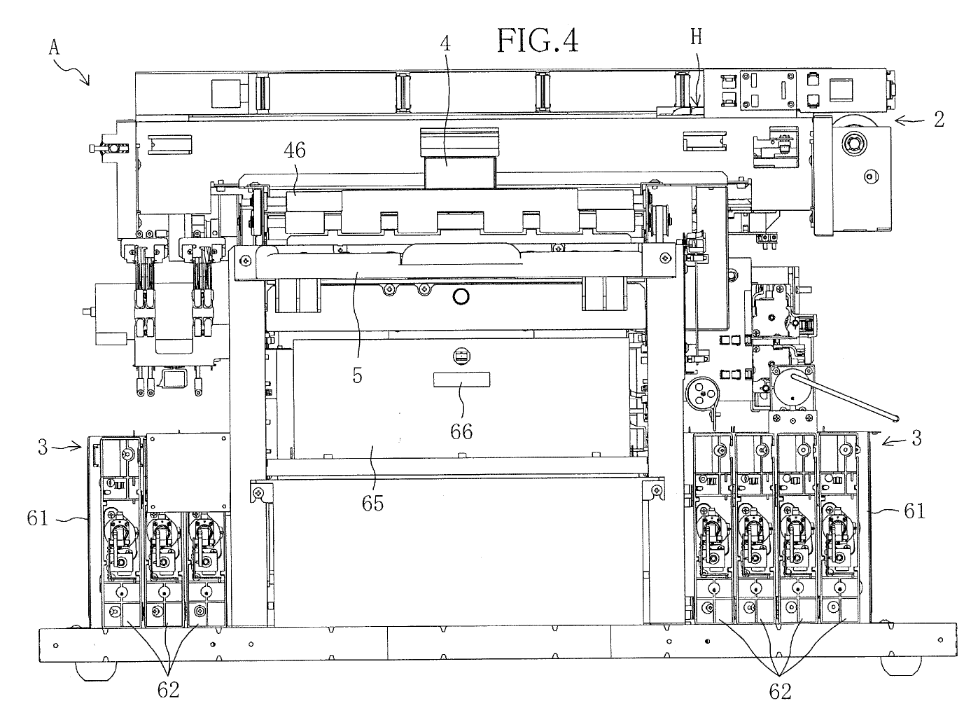

The ink storages 3 include their respective box-shaped cases 61 (see FIG. 4) disposed on the right and left of the inkjet printer A. These cases 61 contain seven removable ink cartridges in total (in FIG. 4, three in the left case 61 and four in the right case 61). The ink cartridges 62 are charged with different types of ink having different hues. Therefore, the ink cartridges 62 spent or being used can be replaced with new ones by removing them from the cases 61 and setting new ones in the cases 61. Seven types of ink charged in these ink cartridges 62 are yellow (Y), magenta (M), cyan (C), black (K), red (R), violet (V) and clear (CL).

The cutter unit U3 includes a roller cutter 41 and is configured to cut the printing paper P1 or P2 into a given size (length) by moving the roller cutter 41 in the width direction at an appropriate position of the length of the printing paper P1 or P2 while rotating the roller cutter 41.

Disposed below the roller cutter 41 is a chip collecting box 65 for collecting chips of the printing paper P1 or P2 formed by the cutting. The chip collecting box 65 is configured so that the operator can slide it out of the housing 6 by pulling its handle 66 and take out the chips collected in it.

The piece of printing paper P1 or P2 cut by the cutter unit U3 is conveyed to the paper output unit U4 by a pair of conveyance rollers 43 engaged against each other. The back printing unit 4 is disposed between the cutter unit U3 and the paper output unit U4. In the back printing unit 4, a serial number or the like is printed on the back (underside) of the printing paper P1 or P2 passing through it.

The paper output unit U4 includes two pairs of output rollers 45 and 46 for conveying the piece of printing paper P1 or P2 and delivering it to the decurling unit U7.

The conveyance rollers 43 and the output rollers 45 and 46 are configured to be synchronously driven into rotation by an unshown electric motor. Furthermore, the later-described conveyance roller 81 and decurling roller 82 of the decurling unit U7 are likewise configured to be driven into rotation in synchronism with the conveyance rollers 43 and the output rollers 45 and 46.

Furthermore, each pair of conveyance rollers 43 and output rollers 45 and 46 are configured to be disengaged one from the other before the leading edge of the printing paper P1 or P2 conveyed by the upstream conveyance drive roller 24 and print conveyance rollers 33 is pinched between the pair.

Specifically, when the printing paper P1 or P2 is conveyed from the conveyance drive roller 24 and the print conveyance rollers 33 towards the pair of conveyance rollers 43, the upper conveyance roller moves up and disengages from the lower conveyance roller before the leading edge of the printing paper P1 or P2 contacts the pair of conveyance rollers 43. Likewise, when the printing paper P1 or P2 having passed through the conveyance rollers 43 is conveyed towards each of the two pairs of output rollers 45 and 46, the upper roller of each pair of output rollers 45 and 46 moves up and disengages from the lower roller before the leading edge of the printing paper P1 or P2 contacts the pair of output rollers. This eliminates inconveniences, such as creases of the printing paper P1 or P2 formed owing to its leading edge lodging on the conveyance rollers 43 and the output rollers 45 and 46.

Furthermore, after the printing of an image in the print unit U2 and before the cutting of the printing paper P1 or P2 in the cutter unit U3, the upper rollers of the pair of conveyance rollers 43 and the pairs of output rollers 45 and 46, which have been moved up, are concurrently returned to their positions of engagement against the lower rollers, thereby pinching the printing paper P1 or P2. This prevents the printing paper P1 or P2 from being displaced when being cut, which ensures accurate paper cutting.

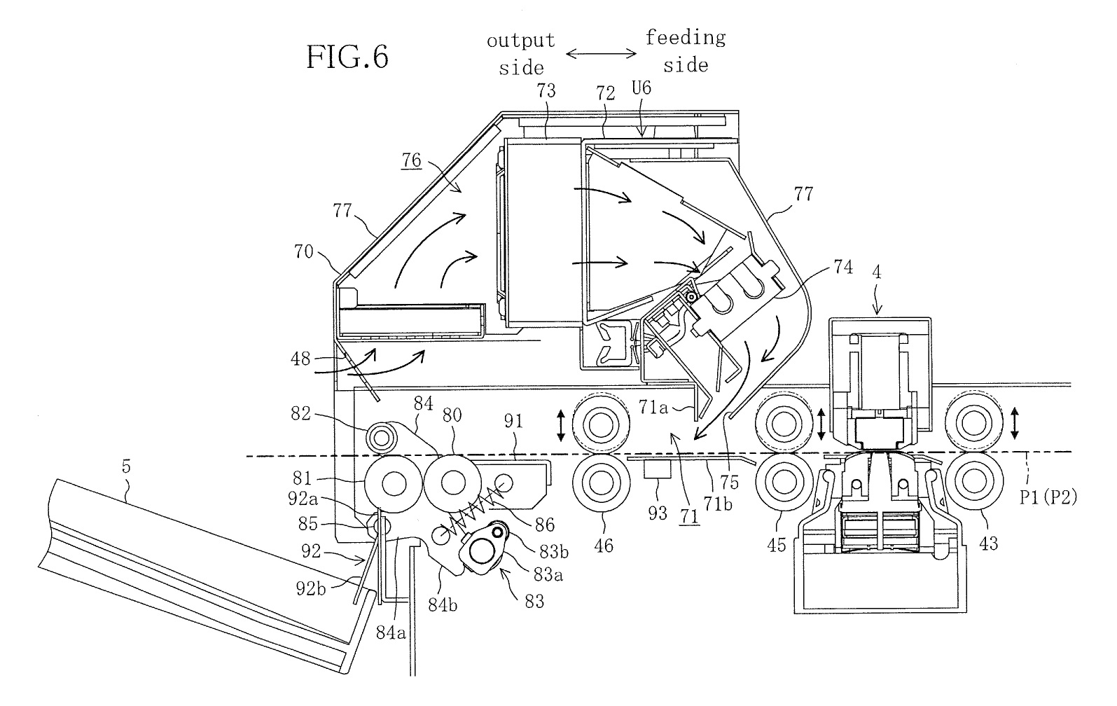

The drying unit U6 is, as shown in FIG. 6, disposed between two pairs of engageable rollers in the paper output unit U4, i.e., between the pair of upstream output rollers 45 and the pair of downstream output rollers 46. The drying unit U6 is configured to suck air into the housing 6 through an air inlet 48 formed in the housing 6 above and in the vicinity of the paper output port, apply heat to the sucked air and blow out the air as dry air.

The drying unit U6 includes a drying chamber 71 disposed on the conveyance path of the printing paper P1 or P2, a dryer 72 for supplying dry air to the drying chamber 71 and an outside cover 70 for introducing the air sucked in the housing 6 through the air inlet 48 to the dryer 72. The drying chamber 71 is defined by an upper partition wall 71a and a lower partition wall 71b that are opposed to each other with the printing paper P1 or P2 therebetween, and constitutes a retention space for retaining dry air blown against the printing paper P1 or P2 from the dryer 72.

The dryer 72 includes a plurality of intake fans 73 disposed in the housing 6 at laterally spaced intervals to take air from the outside through the air inlet 48 of the housing 6 into the dryer 72, a heater 74 for heating the air taken in by the intake fans 73, and an exhaust nozzle 75, disposed at the lower end of the dryer 72 and opening downstream in the direction of paper conveyance, for blowing dry air heated by the heater 74 therethrough downstream in the direction of paper conveyance.

The outside cover 70 is disposed above the paper output port of the housing 6 and configured to allow air sucked in the housing 6 through the air inlet 48 to flow through a flow space 76 located in the outside cover 70 and introduce the air to the intake fans 73. The outside cover 70 has an openable and closable rear door formed in the surface thereof. Since such a drying unit U6 is provided, the blow of dry air promotes the drying of ink ejected from the print head H to the printing paper P1 or P2 even if the ink on the printed piece of paper is not yet dried.

### Decurling Unit

A description is given below of the structure of the decurling unit U7, which is a feature of the present invention. As shown in FIG. 6, the decurling unit U7 is configured to perform a decurling process of correcting the curl of a piece of rolled paper web P2 and includes a conveyance roller 81 for conveying a piece of printing paper P1 or P2 to the paper output tray 5, a decurling roller 82 for pinching the piece of printing paper P1 or P2 together with the conveyance roller 81, and a position changing roller 83 (roller position changing mechanism) for changing the relative position of the decurling roller 82 to the conveyance roller 81. Furthermore, a free roller 80 is disposed upstream of the conveyance roller 81 to rotate in conjunction with the movement of the piece of printing paper P1 or P2 being conveyed.

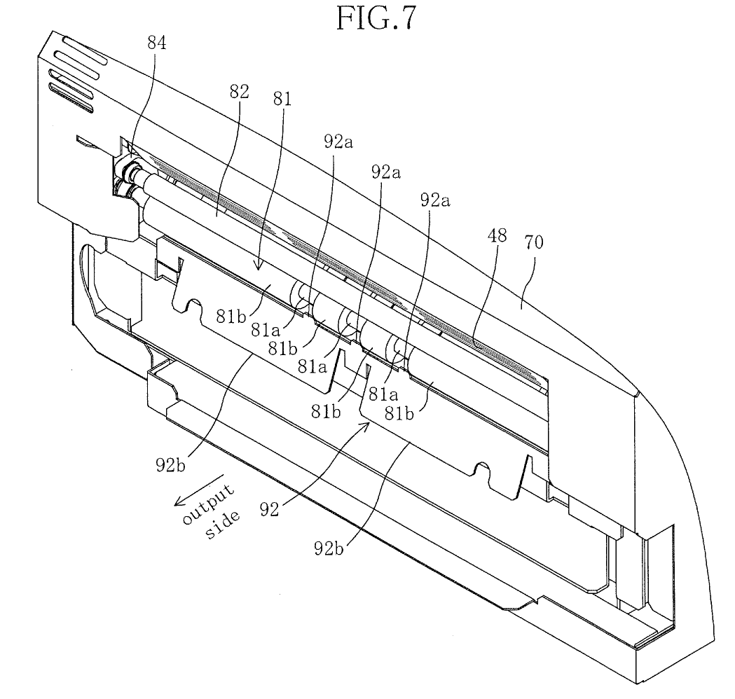

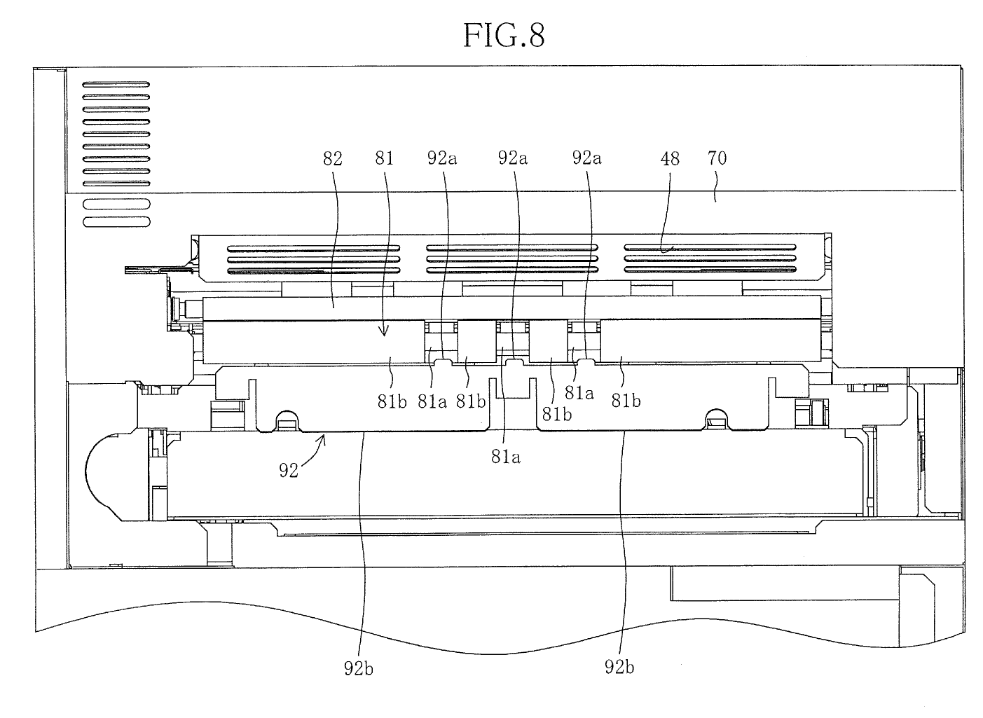

The conveyance roller 81 is, as shown in FIGS. 7 and 8, composed of a roller shaft 81a extending in the width direction of the printing paper P1 or P2 and a plurality of roller bodies 81b, 81b, . . . arranged at spaced intervals in the axial direction of the roller shaft 81a. Dry air residing in the drying chamber 71 is blown through between each adjacent roller bodies 81b and 81b out of the housing 6, thereby preventing heat from staying in the interior of the housing 6. Although not shown, the free roller 80 may be configured, like the conveyance roller 81, so that a plurality of roller bodies are arranged at axially spaced intervals or may be configured to continuously extend in the axial direction.

Disposed on the downstream side of the conveyance roller 81 is a guide member 92 for smoothly feeding the piece of printing paper P1 or P2 output from the conveyance roller 81 towards the paper output tray 5 while guiding the trailing edge thereof to prevent it from being caught by the conveyance roller 81. The guide member 92 includes a pair of laterally arranged guide plates 92b and 92b, extending in the axial direction of the conveyance roller 81 to cover the lower edge of the conveyance roller 81, for guiding the piece of printing paper P1 or P2 to the paper output tray 5, and projections 92a, 92a, . . . , projecting from the upper edge of the guide plates 92b and 92b to come between each adjacent roller bodies 81b and 81b, for guiding the trailing edge of the piece of printing paper P1 or P2 against being caught between each adjacent roller bodies 81b and 81b.

The decurling roller 82 has a smaller diameter than the conveyance roller 81, extends continuously in the width direction of the printing paper P1 or P2 and is disposed travelably substantially along the roller surface of the conveyance roller 81.

Specifically, a shaft end of the decurling roller 82 is rotatably attached to a lever 84. The lever 84 includes a substantially C-shaped attachment part 84a whose distal end is bifurcated downstream when viewed from one side and an abutment part 84b extending obliquely downward from the upstream side of the lower end of the attachment part 84a. The decurling roller 82 is rotatably attached to the upper distal end of the generally C-shaped attachment part 84a, while a lever shaft 85 is attached to the lower distal end thereof. The decurling roller 82 is configured to be travelable substantially along the roller surface of the conveyance roller 81 by pivotally moving the lever 84 about the lever shaft 85. It will suffice if the decurling roller 82 has a configuration capable of traveling around the conveyance roller 81. Therefore, in addition to the decurling roller 82 travelable substantially along the roller surface of the conveyance roller 81, various traveling types of decurling rollers 82 can be applied to the decurling mechanism.

Furthermore, a bias spring 86 is anchored to the abutment part 84b of the lever 84 and an attachment bracket 91 disposed to the upstream side of the free roller 80 to urge the lever 84 towards rotating counterclockwise in FIG. 6 and putting the decurling roller 82 into the later-described pinch release position.

Disposed on the upstream side of the lever 84 is the position changing roller 83 for pressing the lever 84 while abutting on the abutment part 84b to rotate the lever 84 clockwise against the urging force of the bias spring 86. The position changing roller 83 includes a main body 83a pivotable about a pivot shaft extending in the width direction and a roller body 83b rotatably attached to the upper end of the main body 83a and capable of abutting on the abutment part 84b. The main body 83a is configured to be pivotally moved about the pivot shaft by an unshown pulse motor.

Furthermore, the position changing roller 83 is configured to change the relative position of the decurling roller 82 to the conveyance roller 81 by changing its angle of rotation and pushing the lever 84 while allowing its roller body 83b to abut on the abutment part 84b of the lever 84.

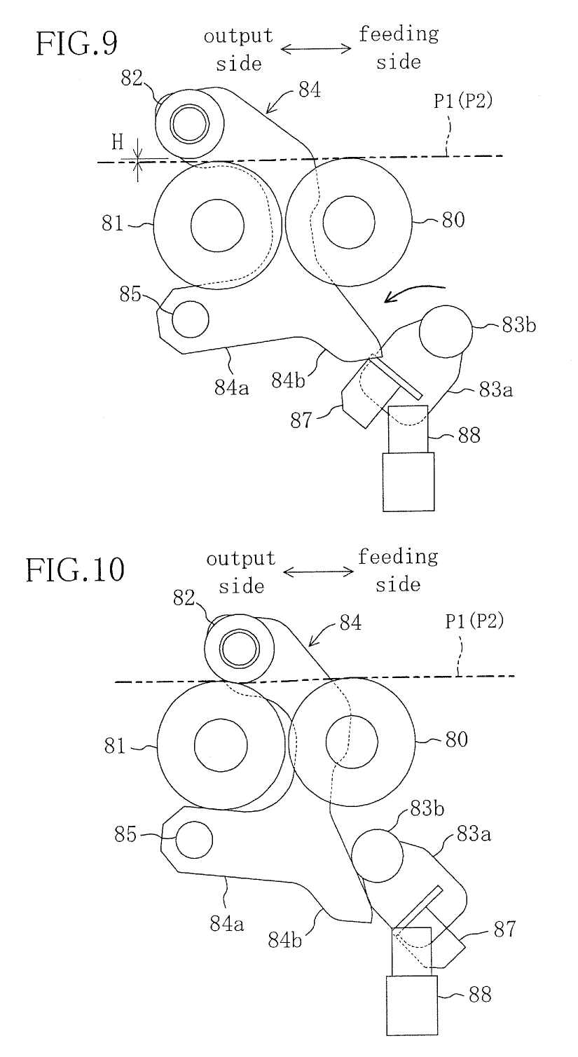

More specifically, as shown in FIG. 9, when the roller body 83b of the position changing roller 83 is not allowed to abut on the abutment part 84b of the lever 84, the lever 84 is positioned in the pinch release position, which is the leftmost position, by the urging force of the bias spring 86. In the pinch release position, a given clearance H is created between the conveyance roller 81 and the decurling roller 82, whereby the pinch of the printing paper P1 or P2 is released. A detection lug 87 is attached to the main body 83a of the position changing roller 83. When the detection lug 87 deviates to the left from a transmission sensor 88, it is detected that the decurling roller 82 is positioned in the pinch release position.

With the above configuration, when the paper conveyance is stopped in order to form an image on a piece of printing paper P1 or P2, the movement of the decurling roller 82 to the pinch release position provides the release of a printed piece of printing paper P1 or P2 from the pinch between the conveyance roller 81 and the decurling roller 82, thereby eliminating an inconvenience that an indentation of the conveyance roller 81 and the decurling roller 82 is left on the printed piece of printing paper P1 or P2 and the printing quality is thereby deteriorated.

Next, as shown in FIG. 10, the main body 83a of the position changing roller 83 is pivotally moved counterclockwise to press the roller body 83b against the abutment part 84b of the lever 84 until the transmission sensor 88 detects the detection lug 87. Thus, the lever 84 is pivotally moved clockwise against the urging force of the bias spring 86 to position the decurling roller 82 in the conveyance position in which a piece of printing paper P1 or P2 is conveyed without being subjected to decurling. Furthermore, in the conveyance position, the decurling roller 82 is positioned upstream from the conveyance roller 81.

With the above configuration, a clearance is created between the conveyance roller 81 and the decurling roller 82 unlike the case where both the rollers 81 and 82 are vertically juxtaposed with respect to the direction of paper conveyance. Thus, the pinching force of both the rollers 81 and 82 against the piece of printing paper P1 or P2 can be reduced to reduce the load applied to the piece of printing paper P1 or P2. In this case, the piece of printing paper P1 or P2 is conveyed in a slightly sagging state. Therefore, the restoring force of the piece of printing paper P1 or P2 towards stretching straight and the frictional force between the piece of printing paper P1 or P2 and the pair of rollers 81 and 82 provide smooth conveyance of the piece of printing paper P1 or P2 using the elasticity of the piece of printing paper P1 or P2.

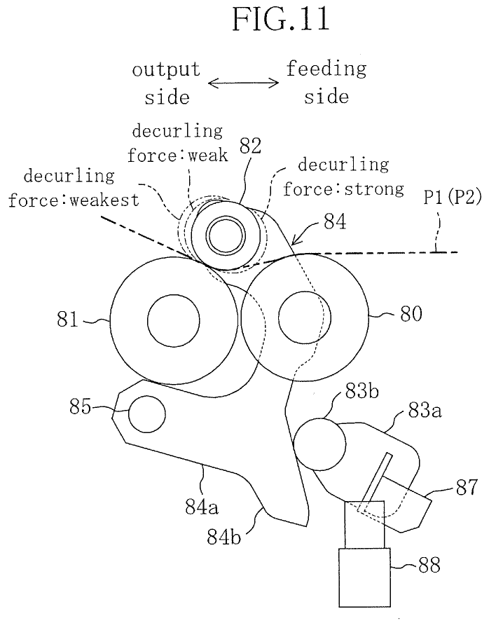

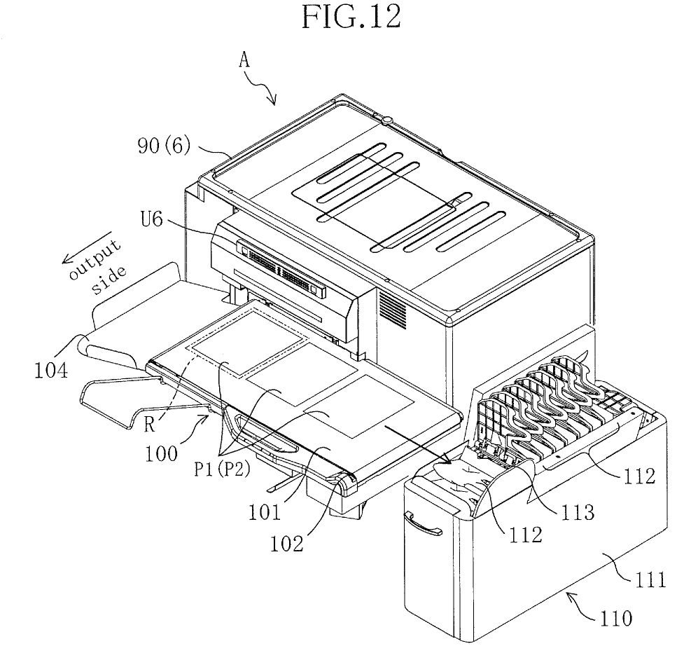

Then, as shown in FIG. 11, the main body 83a of the position changing roller 83 is further pivotally moved counterclockwise to press the roller body 83b against the abutment part 84b until the detection lug 87 deviates to the right from the transmission sensor 88 and is not detected by it. Thus, the decurling roller 82 is positioned in the decurling position in which a piece of paper web P2 is conveyed while being decurled.

In this case, the clearance between the decurling roller 82 and the conveyance roller 81 when the decurling roller 82 is in the decurling position is set to be larger than that when the decurling roller 82 is in the conveyance position. Specifically, the clearance between the decurling roller 82 and the conveyance roller 81 is set to be larger than the thickness of the paper web P2 when the decurling roller 82 is in the decurling position, while the clearance is set to be smaller than the thickness of the paper web P2 when the decurling roller 82 is in the conveyance position.

Thus, in moving the decurling roller 82 from the conveyance position to the decurling position, the clearance is gradually changed, which prevents a strong pressing force from rapidly acting on the restoring force of the piece of paper web P2 towards stretching straight and minimizes damage to the piece of paper web P2.

A plurality of decurling positions are set substantially along the roller surface of the conveyance roller 81 (and shown in the imaginary lines in FIG. 11). In an example shown in FIG. 11, the position of the decurling roller 82 shown in the solid line is a reference decurling position, the position of the decurling roller 82 moved clockwise from the reference position is a strong decurling position where the decurling force of the decurling roller 82 is strong, the position of the decurling roller 82 moved counterclockwise from the reference position is a weak decurling position where the decurling force is weak, and the position of the decurling roller 82 further moved counterclockwise from the weak decurling position is a weakest decurling position where the decurling force is weakest. The position changing roller 83 adjusts the strength of the decurling force to the paper web P2 by moving the decurling roller 82 among the plural decurling positions from the weakest to the strong decurling position.

With the above configuration, an appropriate decurling force to the shape of a curl of the piece of paper web P2 can be applied to the piece of paper web P2. Specifically, part of the paper web P2 in the vicinity of the core around which the paper web P2 is rolled has a small radius of curvature and is therefore strongly curled, while part of the paper web P2 in the vicinity of the outer periphery thereof has a large radius of curvature and is therefore weakly curled. To cope with this, instead of curls of pieces of paper web P2 being always corrected with a constant decurling force, the strength of the decurling force is adjusted according to the shapes of curls of pieces of paper web P2. Thus, the curl of each piece of the paper web P2 can be corrected with an optimum decurling force.

Furthermore, the strength of the decurling force applied to each cut piece of the paper web P2 may be adjusted according to the length of the piece of paper web P2. Specifically, a longer piece of paper web P2 can be determined to be more flexible and more strongly curled. Therefore, if the piece of paper web P2 has a length not smaller than a predetermined value, the decurling force applied to the piece of paper web P2 is set large. On the other hand, if the piece of paper web P2 has a length smaller than the predetermined value, the decurling force applied to the piece of paper web P2 is set small. Thus, it can be prevented that a stronger decurling force than necessary is applied to the piece of paper web P2 and that the piece of paper web P2 is curled opposite to the actual curl. Furthermore, it can be prevented that a weak decurling force for the degree of actual curl is applied to the piece of paper web P2. This eliminates an inconvenience that the curl cannot sufficiently be corrected.

Furthermore, the strength of the decurling force applied to each cut piece of paper web P2 may be adjusted according to the material of the paper web P2. Specifically, a paper web P2 made of a hard material having a strong elasticity is difficult to flex. Therefore, an appropriate decurling force with which each cut piece of paper web P2 can be easy to decurl is applied to the piece of paper web P2, such as by setting a large decurling force for the paper web P2 made of a hard material having a strong elasticity or by setting a small decurling force for the paper web P2 made of a relatively soft material.

Furthermore, the strength of the decurling force applied to each cut piece of the paper web P2 may be adjusted according to the time elapsed from the date of production of the paper web P2. Specifically, information on the date of production of the paper web P2 is stored such as in a non-contact IC chip provided in the core for the paper web P2 and the strength of the decurling force applied to each cut piece of the paper web P2 is adjusted according to the time elapsed from the date of production by reading the information on the date of production. For example, if a predetermined period of time has passed since the date of production of the paper web P2, the cut piece of paper web P2 can be determined to be strongly curled. Therefore, the decurling force applied to the cut piece may be set large. On the other hand, if the predetermined period of time has not yet passed since the date of production of the paper web P2, the decurling force applied to the cut piece may be set small.

Alternatively, for example, the strength of the decurling force may be adjusted according to the humidity or temperature in the paper roll containing part 1. Specifically, if the interior of the paper roll containing part 1 is dry or has a low temperature, the cut piece of paper web P2 can be determined to be strongly curled. In such a case, the decurling force applied to the cut piece may be set large.

The under surface of the lower partition wall 71b defining part of the drying chamber 71 of the drying unit U6 has a detection sensor 93 provided on a downstream part thereof to detect the leading edge and trailing edge of a piece of printing paper P1 or P2. When the detection sensor 93 detects the leading edge of the piece of printing paper P1 or P2, the decurling roller 82 of the decurling unit U7 is moved from the decurling position or conveyance position to the pinch release position. Thus, the conveyance roller 81 and the decurling roller 82 can smoothly pinch the piece of printing paper P1 or P2 when the piece of printing paper P1 or P2 is transferred from the paper output unit U4 to the decurling unit U7. This eliminates inconveniences, such as creases of the piece of printing paper P1 or P2 formed owing to its leading edge lodging on the conveyance roller 81 and the decurling roller 82.

On the other hand, when the detection sensor 93 detects the trailing edge of the piece of printing paper P1 or P2, the piece of printing paper P1 or P2 is conveyed a predetermined length from the point in time of detection until the trailing edge of the piece of printing paper P1 or P2 reaches a point between the free roller 80 and the conveyance roller 81 and, then, the decurling roller 82 of the decurling unit U7 is moved from the decurling position to the pinch release position. Thus, in conjunction with movement of the decurling roller 82 from the decurling position or the conveyance position to the pinch release position, the trailing edge of the piece of printing paper P1 or P2 is moved at a stroke to the paper output tray 5. Therefore, the output speed of the piece of printing paper P1 or P2 increases, which provides smooth transfer of the piece of printing paper P1 or P2 to the paper output tray 5. If, in sending out the trailing edge of the piece of printing paper P1 or P2, the conveyance roller 81 is controlled to rotate at high speed, this provides further smooth transfer of the piece of printing paper P1 or P2, which is preferable.

Furthermore, since the decurling unit U7 is disposed downstream of the drying unit U6 to decurl the piece of paper web P2 just after being dried by the drying unit U6, this is advantageous in appropriately correcting the curl of the piece of paper web P2. Specifically, the piece of paper web P2 heated by dry air from the drying unit U6 is very likely to be deformed. Therefore, if the piece of paper web P2 in this state is decurled by the decurling unit U7, a higher decurling effect can be obtained than when the piece of paper web P2 is not heated.

As described so far, in the inkjet printer A including the decurling unit U7 according to the first example embodiment, the strength of the decurling force applied to each cut piece of paper web P2 is adjusted according to various factors including the length of the cut piece and the material thereof. Therefore, the decurling force can be appropriately adjusted according to the degree of curl of each cut piece of paper web P2 to correct the curl. Thus, it can be prevented that a stronger decurling force than necessary is applied to the piece of paper web P2 and that the piece of paper web P2 is curled opposite to the actual curl. Furthermore, it can be prevented that a weak decurling force for the degree of actual curl is applied to the piece of paper web P2. This eliminates an inconvenience that the curl cannot sufficiently be corrected.

### Second Example Embodiment

FIG. 12 is a perspective view showing the structure of an inkjet printer according to a second example embodiment of the present invention. This example embodiment is different from the first example embodiment in that a conveyance unit 100 and an collection unit 110 are provided instead of the paper output tray 5. Therefore, the same parts are identified by the same reference numerals as in the first example embodiment and a description is given only of different points.

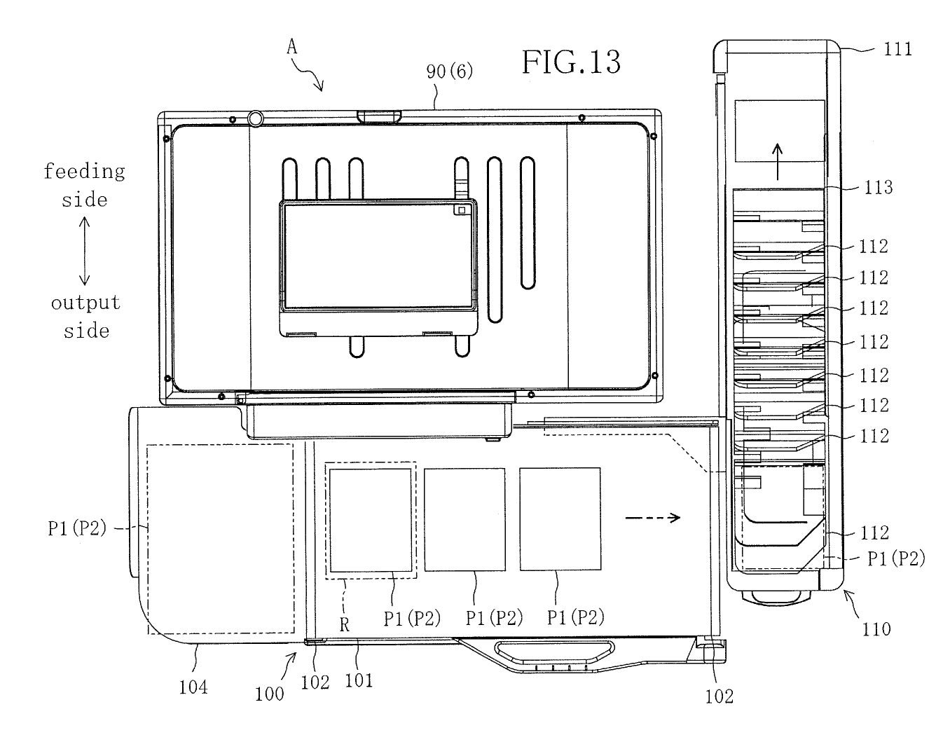

As shown in FIGS. 12 and 13, the inkjet printer A includes a printer body 90, a conveyance unit 100 disposed downstream of the printer body 90, and a collection unit 110 disposed downstream of the conveyance unit 100 in the direction of paper conveyance. The printer body 90 has substantially the same structure as described in the first example embodiment and, therefore, a description thereof is not given.

The conveyance unit 100 constitutes a paper placement mechanism for receiving pieces of printing paper P1 or P2 output through the paper output port in the housing 6 of the printer body 90 and includes a conveying belt 101 for conveying pieces of printing paper P1 or P2 placed thereon downstream like a belt conveyer, a drive roller 102 for driving the conveying belt 101 and a large-sized tray 104 disposed upstream of the conveying belt 101 in the direction of paper conveyance. “Downstream of the conveyance unit 100 in the direction of paper conveyance” means to the right of the housing 6.

The region of the conveying belt 101 corresponding to the paper output port in the housing 6 is set to a placement region R where a piece of printing paper P1 or P2 just after being output through the paper output port is received. Furthermore, the conveyance unit 100 is configured to control the movement of the conveying belt 101 to allow the already placed piece of printing paper P1 or P2 to leave the placement region R before the next piece of printing paper P1 or P2 to be output through the paper output port in the housing 6 is placed on the placement region R.

Thus, pieces of printing paper P1 or P2 can be prevented from being stacked one after another, which prevents inconveniences, such as a phenomenon that ilk on each printed piece of printing paper P1 or P2 is not uniformly dried to cause color shading of printed images.

The control on the movement of the conveying belt 101 is implemented by adjusting the speed of paper conveyance so that when the piece of printing paper P1 or P2 already placed on the placement region R leaves the placement region R, the next piece of printing paper P1 or P2 is output. Furthermore, instead of continuing to drive the conveying belt 101 at a constant speed, pieces of printing paper P1 or P2 may be intermittently conveyed so that the piece of printing paper P1 or P2 already placed on the placement region R can be conveyed at a stroke to the outside of the placement region R when the next piece of printing paper P1 or P2 is conveyed.

In this case, if a piece of printing paper P1 or P2 such as of L print size is placed on the conveying belt 101, the conveyance unit 100 is controlled to convey the piece of printing paper P1 or P2 to the collection unit 110 disposed downstream thereof in the direction of paper conveyance. On the other hand, if a piece of printing paper P1 or P2 having a larger print size, such as B5 or A4, is placed on the conveying belt 101, the conveyance unit 100 is controlled to convey the piece of printing paper P1 or P2 to the large-sized tray 104 located upstream thereof in the direction of paper conveyance. In this manner, by changing the direction of paper conveyance according to the size of piece of printing paper P1 or P2, pieces of printing paper P1 or P2 can be conveyed to appropriate accommodation sites for each paper size.

The collection unit 110 is disposed downstream of the conveyance unit 100 in the direction of paper conveyance and configured to collect pieces of printing paper P1 or P2 conveyed from the conveyance unit 100. The collection unit 110 includes a collecting body 111, a plurality of collecting plates 112, arranged at spaced intervals in the collecting body 111, for placing pieces of printing paper P1 or P2 conveyed from the conveyance unit 100 thereon, and a collecting belt 113 for conveying the plurality of collecting plates 112 towards the rear of the housing 6 like a belt conveyer.

Each collecting plate 112 stands by at a transfer point for pieces of printing paper P1 or P2 located downstream of the conveying belt 101 so that the plate surface is horizontal and substantially flush with the surface of the conveying belt 101. Then, when a predetermined number of pieces of printing paper P1 or P2 are stacked on the collecting plate 112 according to the print order, the collecting plate 112 is conveyed to the rear of the housing 6 by the collecting belt 113 before the next piece of printing paper P1 or P2 is conveyed according to the next print order. Then, the surface of the collecting plate 112 having been held horizontal stands up in the course of conveyance of the collecting belt 113 to function as a partition plate for partitioning pieces of printing paper P1 or P2 for each print order.

In this case, the conveyance unit 100 controls the movement of the conveying belt 101 so that when the piece of printing paper P1 or P2 is transferred from the conveying belt 101 to each collecting plate 112 of the collection unit 110, the speed of conveyance of the piece of printing paper P1 or P2 reaches a predetermined speed or more. Specifically, a clearance is left between the conveying belt 101 and the collecting plate 112 facing it. Therefore, if the speed of paper conveyance of the conveying belt 101 is too late, the edge of the piece of printing paper P1 or P2 may drop in the clearance, leading to failure of smooth paper transfer or failure of paper transfer. To avoid this, the speed of paper conveyance of the conveying belt 101 is controlled to be a speed at which the piece of printing paper P1 or P2 can be stably transferred, thereby ensuring the transfer of the piece of printing paper P1 or P2.

As described so far, in the inkjet printer A including the decurling unit U7 according to the second example embodiment, pieces of paper web P2 after being decurled in the decurling unit U7 are partitioned with the collecting plates 112 for each print order, whereby the pieces of printing paper P1 or P2 can be easily set in each order. Furthermore, since the number of pieces of printing paper P1 or P2 accommodated can be increased, the frequency with which the worker picks up pieces of printing paper P1 or P2 after being printed can be reduced, which increases the working efficiency.

As seen from the above description, the present invention has a highly practical effect that the decurling force can be appropriately adjusted according to the degree of curl of the paper. Therefore, the present invention is very useful and has high industrial applicability.

What is claimed is:

1. A decurling mechanism for performing a decurling process of correcting a curl of a piece of paper, the decurling mechanism being configured so that the decurling force applied to the piece of paper is set small when the piece of paper has a length smaller than a predetermined value but set large when the piece of paper has a length not smaller than the predetermined value.

2. The decurling mechanism of claim 1, wherein the decurling mechanism is configured to adjust the strength of the decurling force applied to the piece of paper according to the material of the paper.

3. The decurling mechanism of claim 1, wherein the decurling mechanism is configured to adjust the strength of the decurling force applied to the piece of paper according to the elapsed time from the date of production of the paper.

4. The decurling mechanism of claim 1, wherein the decurling mechanism comprises:
a conveyance roller for conveying the piece of paper to a predetermined paper output point;
a decurling roller, disposed travelably around the conveyance roller, for pinching the piece of paper together with the conveyance roller; and
a roller position changing mechanism for changing the relative position of the decurling roller to the conveyance roller to at least two positions including a decurling position in which the piece of paper is conveyed while being decurled and a conveyance position in which the piece of paper is conveyed without being decurled,
the decurling position comprises a plurality of decurling positions set substantially along the roller surface of the conveyance roller, and
the roller position changing mechanism is configured to adjust the strength of the decurling force applied to the piece of paper by moving the decurling roller among the plurality of decurling positions.
